(19) United States
(12) Patent Application Publication
(10) Pub. No.: US 2025/0211526 A1
(43) Pub. Date: Jun. 26, 2025

(54) RELAY DEVICE, RELAY METHOD, AND RECORDING MEDIUM

(71) Applicant: Panasonic Automotive Systems Co., Ltd., Kanagawa (JP)

(72) Inventor: Akihiko IGUCHI, Osaka (JP)

(73) Assignee: Panasonic Automotive Systems Co., Ltd., Kanagawa (JP)

(21) Appl. No.: 18/952,361

(22) Filed: Nov. 19, 2024

(30) Foreign Application Priority Data
Dec. 22, 2023 (JP) 2023-217288

(51) Int. Cl. H04L 45/74; G07C 5/08; H04L 69/22

(52) U.S. Cl. CPC H04L 45/74; G07C 5/0808; H04L 69/22

(57) ABSTRACT

A relay device relays a frame through connection-oriented communication between a first communication device and one or more second communication devices, and the frame includes in a header portion: a destination address that designates the relay device; and an upper-layer address that designates a second communication device as a transmission destination in an upper-layer protocol higher than a connection protocol. The relay device includes: a communicator that receives the frame from the first communication device; a controller that determines whether a table includes a first address and is the upper-layer address of the second communication device; an analyzer that analyzes the payload of the frame to identify a second address that is the destination address of the second communication device, when the first address is not included in the table; and an updater that updates the table based on the first address and the second address.

### CROSS REFERENCE TO RELATED APPLICATION

The present application is based on and claims priority of Japanese Patent Application No. 2023-217288 filed on Dec. 22, 2023.

### FIELD

The present disclosure relates to a relay device, a relay method, and a recording medium.

### BACKGROUND

Patent Literature (PTL) 1 discloses a relay device capable of reducing the processing load when relaying a frame that includes a description based on a protocol in a layer higher than that used in connection-oriented communication.

### CITATION LIST

### Patent Literature

PTL 1: Japanese Patent No. 7200803

### SUMMARY

However, the relay device according to PTL 1 can be improved upon.

In view of this, the present disclosure provides a relay device, a relay method, and a recording medium capable of improving upon the above related art.

A relay device according to one aspect of the present disclosure is a relay device that relays a frame transmitted and received through connection-oriented communication between a first communication device and each of one or more second communication devices, the frame including in a header portion: a destination address that designates the relay device in a connection protocol for performing the connection-oriented communication; and an upper-layer address that designates a second communication device as a transmission destination in an upper-layer protocol higher than the connection protocol, the relay device including: a communicator that receives the frame from the first communication device; a controller that determines whether a first address is included in a table associating the destination address with the upper-layer address, the first address being acquired based on the header portion of the frame received by the communicator, and being the upper-layer address of the second communication device as the transmission destination for the frame among the one or more second communication devices; an analyzer that analyzes a payload of the frame to identify a second address that is the destination address of the second communication device as the transmission destination for the frame, when the first address is not included in the table; and an updater that updates the table based on additional information associating the first address with the second address.

A relay method according to one aspect of the present disclosure is a relay method A relay method executed by a relay device that relays a frame transmitted and received through connection-oriented communication between a first communication device and each of one or more second communication devices, the frame including in a header portion: a destination address that designates the relay device in a connection protocol for performing the connection-oriented communication; and an upper-layer address that designates a second communication device as a transmission destination in an upper-layer protocol higher than the connection protocol, the relay method including: receiving the frame from the first communication device; determining whether a first address is included in a table associating the destination address with the upper-layer address, the first address being acquired based on the header portion of the frame received, and being the upper-layer address of the second communication device as the transmission destination for the frame among the one or more second communication devices; analyzing a payload of the frame to identify a second address that is the destination address of the second communication device as the transmission destination for the frame, when the first address is not included in the table; and updating the table based on additional information associating the first address with the second address.

According to one aspect of the present disclosure, it is possible to implement a relay device and the like capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a configuration of a communication system according to an embodiment.

FIG. 2 is a block diagram illustrating a functional configuration of a gateway switch (SW) according to the embodiment.

FIG. 3 is a diagram illustrating an example of a table according to the embodiment.

FIG. 4 is a sequence diagram illustrating a first example of operations of the communication system according to the embodiment.

FIG. 5 is a diagram illustrating a first example of a determination result displayed by a display device according to the embodiment.

FIG. 6 is a sequence diagram illustrating a second example of the operations of the communication system according to the embodiment.

FIG. 7 is a diagram illustrating a second example of the determination result displayed by the display device according to the embodiment.

FIG. 8 is a sequence diagram illustrating a third example of the operations of the communication system according to the embodiment.

FIG. 9 is a diagram illustrating a third example of the determination result displayed by the display device according to the embodiment.

FIG. 10 is a flowchart illustrating operations of the gateway SW according to the embodiment.

### DESCRIPTION OF EMBODIMENTS

### (Circumstances Leading to the Present Disclosure)

In an Ethernet (registered trademark, the same applies hereinafter) switch (hereinafter referred to as a switch) in a vehicle, diagnosis using Diagnostics over Internet Protocol (DoIP) or the like may be used. Since DoIP is based on the premise of a Layer 2 (L2) network, when relaying to an intra-vehicle network domain, a device (a switch, etc.) connected to the L2 network outside the vehicle needs to terminate a Transmission Control Protocol (TCP) connection and perform relaying according to data in a TCP payload. At this time, the switch establishes a TCP connection between a tool and each electronic control unit (ECU) and then performs relay processing using the results of payload analysis, which results in a very large processing load for the relay processing.

To solve such a problem, in the relay device according to PTL 1, a connection tunnel table is prepared in which a connection destination device (ECU) is associated with a logical address. After receiving TCP data from the tool, the switch directly transfers the data to the relay destination ECU according to the connection tunnel table without performing TCP reception processing.

However, in PTL 1, the table for performing direct transfer (connection tunnel table) cannot be automatically updated. This necessitates constant payload analysis when a frame is transmitted to a newly updated or expanded ECU or the like, which is not among pre-set destination combinations in the table, thereby imposing the processing load on the relay device. As described above, the relay device according to PTL 1 has a limited effect in reducing the processing load because the situations in which the processing load can be reduced are limited. In addition, the technique according to PTL 1 may not effectively reduce the processing load on the relay device.

Therefore, the inventor of the present application has diligently studied a relay device and a relay method capable of reducing the processing load more than before and has devised a relay device and a relay method as described below.

Hereinafter, an exemplary embodiment will be described with reference to the drawings.

Note that the embodiment described below provides a general or specific example. The numerical values, shapes, components, arrangement positions and connection forms of the components, steps, the order of the steps, and the like shown in the following embodiment are examples and are not intended to limit the present disclosure. Among the components in the following embodiment, components that are not recited in the independent claims will be described as optional components.

In the figures, substantially identical configurations are denoted by the same reference numerals, and redundant descriptions are omitted or simplified.

In the present specification, numerical values and numerical ranges are not expressions that convey only exact meanings, but expressions that convey the meaning of substantially equivalent ranges, including differences of even about several percent (or about 10%), for example.

In the present specification, ordinal numbers such as “first” and “second” do not mean the number or order of components unless otherwise specified, and are used to avoid confusion and distinguish between components of the same type.

### Embodiment

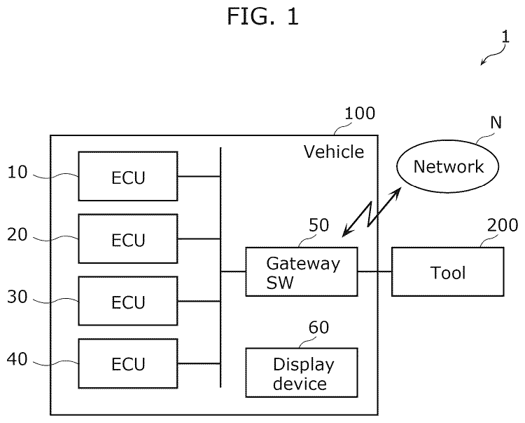

A relay device and a relay method according to the present embodiment will be described below with reference to FIGS. 1 to 10.

### [1. Configuration of Communication System]

First, a configuration of a communication system including the relay device according to the present embodiment will be described with reference to FIGS. 1 to 3. FIG. 1 is a diagram illustrating the configuration of communication system 1 according to the present embodiment. Communication system 1 is a system, for example, with its main part installed in vehicle 100, such as a passenger car, to relay frames between communication devices inside and outside vehicle 100.

As illustrated in FIG. 1, communication system 1 includes vehicle 100 and tool 200. Vehicle 100 includes ECUs 10 to 40 (also referred to as ECU 10 and the like), gateway SW 50, and display device 60. Tool 200 and each of ECU 10 and the like are connected to gateway SW 50 via a communication port (not illustrated) that functions as a transceiver for transmitting and receiving frames, for example. Tool 200 and each of ECU 10 and the like can mutually communicate via gateway SW 50.

Note that an example of transmitting a frame from tool 200 to each of ECU 10 and the like will be described below, but the same applies to a case where a frame is transmitted from each of ECU 10 and the like to tool 200.

Each of ECU 10 and the like is an electronic control device including a function of controlling the components of vehicle 100, such as the engine, air conditioner, and audio system, and additionally includes a communication function to communicate the frame described above. ECU 10 and the like are examples of one or more second communication devices. Note that the number of ECUs included in vehicle 100 is not particularly limited and may be one or more.

Gateway SW 50 relays a frame transmitted and received through connection-oriented communication between tool 200 and each of ECU 10 and the like. Gateway SW 50 is configured as an Ethernet switch. Gateway SW 50 communicates using protocols such as DoIP, Ethernet, and TCP, for example. As an upper-layer protocol, gateway SW 50 may use, for example, Scalable service-Oriented MiddlewarE over Internet Protocol (SOME/IP) or a dedicated protocol corresponding to the function of tool 200, instead of DoIP. As a connection protocol, gateway SW 50 may use, for example, User Datagram Protocol (UDP) instead of TCP.

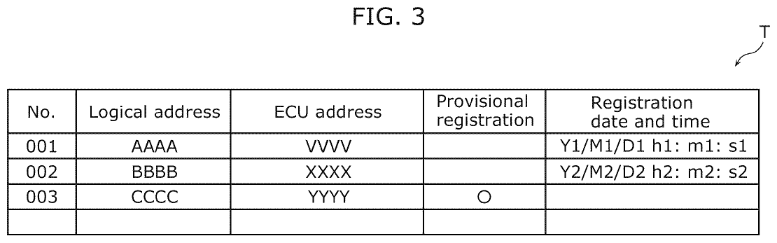

Gateway SW 50 updates a table illustrated in FIG. 3, which will be described later. Gateway SW 50 is an example of a relay device.

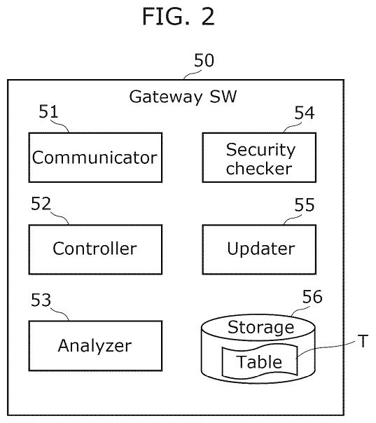

FIG. 2 is a block diagram illustrating the functional configuration of gateway SW 50 according to the present embodiment.

As illustrated in FIG. 2, gateway SW 50 is configured, for example, as hardware equipped with circuits of semiconductor devices and the like, and includes communicator 51, controller 52, analyzer 53, security checker 54, updater 55, and storage 56.

Communicator 51 is a communication interface for gateway SW 50 to communicate with tool 200 and with ECU 10 and the like. Communicator 51 may include corresponding communication ports. Communicator 51 receives, for example, a frame from tool 200. Further, communicator 51 transmits the frame received from tool 200 to the ECU as the transmission destination for the frame. In this frame, the destination address has been converted from that of gateway SW 50 to a second address, which is the connection-protocol address of the ECU as the transmission destination. In addition, communicator 51 transmits, for example, a determination result and the like obtained in gateway SW 50 to display device 60. Note that the communication method may be wired communication or wireless communication.

Note that the frame communicated in communication system 1 includes, for example, a header portion including a Media Access Control (MAC) header, an Internet Protocol (IP) header, a TCP header, and an upper header, and a payload that is actual data. Each header constituting the header portion includes a preamble, a destination address, a source address, a type, and the like. The TCP header includes, in addition to these addresses, a sequence number, an acknowledgement (ACK) number, and various flags. The upper header includes data corresponding to an application. For example, the upper header includes a logical address that is a destination address used in an application. This frame is generated by an application handling a protocol at layer 5 or higher in the Open Systems Interconnection (OSI) reference model and includes a TCP header for communication using TCP, which is a protocol at layer 4 in the OSI reference model. In the present embodiment, DoIP, SOME/IP, or a dedicated protocol prepared for diagnosis, as described above, is used as the protocol at layer 5 or higher.

For example, the header portion of the frame includes a destination address that designates gateway SW 50 in a connection protocol for performing connection-oriented communication, and an upper-layer address that designates an ECU as a transmission destination in an upper-layer protocol higher than the connection protocol. The destination address is an address in the connection protocol, and the upper-layer address is an address in the upper-layer protocol.

Controller 52 is a control device that controls each component of gateway SW 50. Controller 52, for example, performs a process to update a table used for connection-oriented communication (see FIG. 3, to be described later). Controller 52, for example, determines whether a table with pre-registered addresses includes a first address, which is acquired based on the header portion of the frame from tool 200 received by communicator 51, and is the upper-layer address of the ECU as the transmission destination for the frame among ECU 10 and the like.

When the first address is not included in the table, analyzer 53 analyzes the payload of the frame to identify a second address that is the connection-protocol address of the ECU as the transmission destination for the frame. Analyzing the payload of the frame imposes a significant processing load. Therefore, to reduce the processing load on gateway SW 50, it is important to reduce the processing load on analyzer 53.

Security checker 54 performs a security check for tool 200, which transmitted the frame received by communicator 51, using at least one of the following: checksum, payload analysis (such as address), Transport Layer Security (TLS), and Service Identifier (SID) 29, which performs authentication using Unified Diagnostic Service (UDS), a communication protocol for diagnostic testers (in this case, tool 200). The security check for tool 200 may be a security check on tool 200 or a security check on the frame. Security checker 54 is an example of a checker.

Updater 55 executes a process of updating the table based on additional information in which a first address, determined by controller 52 not to be included in the table, is associated with a second address corresponding to the first address. Updater 55 performs provisional registration of the additional information in the table, and when a predetermined condition is satisfied, performs registration (main registration) of the additional information in the table. The predetermined condition will be described later. Note that the provisional registration means temporarily (simply) registering the additional information in the table prior to the main registration. Updating the table may mean provisionally registering the additional information in the table or registering the additional information in the table.

Storage 56 is a storage device that stores various information, various programs, and the like used to execute various processes in gateway SW 50. Storage 56 stores a table or the like for performing connection-oriented communication, in which addresses of ECUs as transmission destinations are associated with logical addresses (see FIG. 3, to be described later). Storage 56 is implemented by, for example, a semiconductor memory, but is not limited thereto.

FIG. 3 is a diagram illustrating an example of table T according to the present embodiment.

As illustrated in FIG. 3, table T is a table in which No., a logical address, an ECU address, provisional registration, and registration date and time are associated with each other.

“No.” represents a number for identification.

“Logical address” represents a destination address used in an application. The logical address is an example of a first address.

“ECU address” represents a destination address used in a TCP connection and includes, for example, an IP address or a MAC address. The ECU address is an example of a second address.

“Provisional registration” represents information for identifying whether a pair of a logical address and an ECU address has been provisionally registered. The example of FIG. 3 shows that the pair of logical address “CCCC” and ECU address “YYYY” has been provisionally registered. In other words, the example of FIG. 3 shows that the pair of logical address “AAAA” and ECU address “VVVV” and the pair of logical address “BBBB” and ECU address “XXXX” have been registered.

“Registration date and time” represents information for identifying whether a pair of a logical address and an ECU address has been registered (main registration), and includes information indicating the date and time of registration. The example of FIG. 3 shows that, since the date and time are written for the pair of logical address “AAAA” and ECU address “VVVV” and the pair of logical address “BBBB” and ECU address “XXXX”, these pairs have been registered. In other words, the example of FIG. 3 shows that the pair of logical address “CCCC” and ECU address “YYYY” has not been registered, that is, the pair has been provisionally registered.

As information indicating whether a pair of a logical address and an ECU address has been registered, table T may include at least one of the provisional registration or the registration date and time.

Note that table T is updated by updater 55.

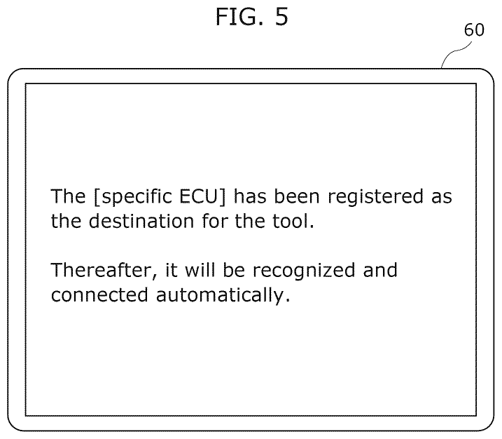

Referring again to FIG. 1, display device 60 is communicatively connected to gateway SW 50 and displays information received from gateway SW 50. Display device 60 may be implemented by a terminal device viewable by a user of tool 200. Display device 60 may be implemented, for example, as a display of a navigation device or as a display of a portable terminal owned by the user, such as a smartphone or tablet. Display device 60 may be implemented as a stationary device or as a portable device. Display device 60 is, for example, a liquid crystal display device, but is not limited thereto. Display device 60 is provided in vehicle 100, but may be provided outside vehicle 100, for example. Information displayed by display device 60 will be described with reference to FIGS. 5, 7, and 9, which will be described later.

Note that display device 60 is an example of a terminal device that presents information to the user. The terminal device is not limited to presenting information via display, but may also present information via sound (for example, voice), light, vibration, or the like.

Tool 200 is configured to be detachable from gateway SW 50 (for example, the communication port of gateway SW 50) and includes a predetermined function. In the present embodiment, tool 200 includes a diagnostic function to diagnose vehicle 100 and is connected to gateway SW 50 as needed, such as during the inspection of vehicle 100 or in similar situations. Note that “detachable” means that tool 200 can be attached to and detached from gateway SW 50 without damaging gateway SW 50 and tool 200.

Tool 200 is a device that, when connected to gateway SW 50, communicates with one or more preset ECUs 10 to 40 to read information such as diagnosis (self-diagnosis) recorded in the memory of these ECUs 10 to 40, and performs vehicle diagnosis based on the read information. Tool 200 is also referred to as a diagnostic tester. Tool 200 also includes a function of rewriting a program stored in each of ECUs 10 to 40 by transmitting a frame to each of ECUs 10 to 40.

Tool 200 can also communicate with a newly connected ECU. The newly connected ECU is, for example, a retrofitted ECU with an ECU address that is not included in previously created table T. Tool 200 is an example of a first communication device.

Network N is a communication network that communicatively connects vehicle 100 to an external device. For example, a communication network such as the Internet is used, but network N is not limited thereto. Network N, for example, communicatively connects vehicle 100 to a security center such as a Security Operations Center (SOC).

### [2. Operations of Communication System]

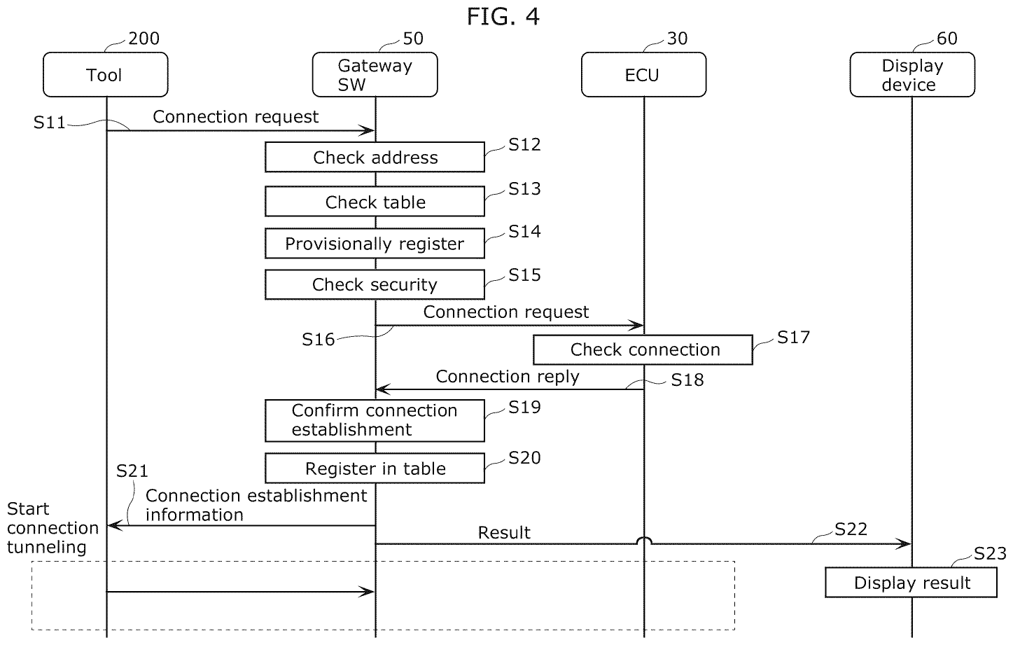

Subsequently, the operations of communication system 1 configured as described above will be described with reference to FIGS. 4 to 10. FIG. 4 is a sequence diagram illustrating a first example of the operations (relay method) of communication system 1 according to the present embodiment. FIG. 4 illustrates operations when a connection between gateway SW 50 and ECU 30 is established.

It is assumed that a connection (TCP connection) has been established between gateway SW 50 and tool 200. It is also assumed that ECU 30 is a newly connected ECU, and table T does not include its logical address or ECU address.

As illustrated in FIG. 4, after connected to gateway SW 50, tool 200 transmits a frame for a connection request to gateway SW 50 (S11). The connection request is a request to communicate with a desired ECU (in the example of FIG. 4, ECU 30). The connection request includes information (header portion, payload) included in the frame described above.

Next, upon receiving the connection request, gateway SW 50 checks the address based on the frame for the connection request (S12). Analyzer 53 of gateway SW 50 acquires a first address, which is the logical address for ECU 30, based on the upper header of the header portion of the frame for the connection request.

Next, gateway SW 50 checks table T (S13) and provisionally registers the address (S14). Controller 52 determines whether the first address acquired in step S12 is included in table T. When controller 52 determines that the first address is not included in table T, analyzer 53 analyzes the payload of the frame for the connection request to identify a second address that is the address in the connection protocol. Updater 55 provisionally registers the pair of the first address and the second address (additional information) in table T. Table T, in which the provisional registration has been performed, corresponds to the table illustrated in FIG. 3

Next, gateway SW 50 checks security (S15). Security checker 54 of gateway SW 50 performs a security check on tool 200 or the frame for the connection request using at least one of the following: checksum, payload analysis (such as address), TLS, and SID 29.

Next, when security checker 54 determines that a security error (as an example of an error) is not present, gateway SW 50 transmits a connection request to ECU 30 (S16). Controller 52 converts the destination address of the frame for the connection request from tool 200 to the second address of ECU 30, and transmits the frame with the converted address to ECU 30 via communicator 51.

Next, upon receiving the connection request, ECU 30 checks the connection (S17), and when communication is possible, ECU 30 transmits a connection reply to gateway SW 50 indicating that communication is possible (S18).

Next, upon receiving the connection reply from ECU 30, gateway SW 50 confirms the connection establishment (S19). For example, controller 52 determines that the connection has been established because the establishment of the connection has been confirmed.

Next, gateway SW 50 performs registration (main registration) of the provisionally registered information in table T (S20). For example, updater 55 registers the provisionally registered information by deleting the check for provisional registration (the circle mark in the example of FIG. 3) corresponding to the provisionally registered information or by adding the registration date and time. The provisionally registered information includes the additional information.

Next, gateway SW 50 transmits connection establishment information indicating that the connection with ECU 30 has been established to tool 200 (S21). This starts connection tunneling between tool 200 and ECU 30. That is, in subsequent communications between tool 200 and ECU 30, analyzer 53 no longer needs to perform payload analysis.

Note that tool 200 may be configured to be able to present the connection establishment information to the user. Tool 200 may include a notifier such as a display that performs a simple display, a light emitter capable of emitting light in a different mode according to the result, or a vibration generator capable of vibrating in a different mode according to the result.

Next, gateway SW 50 transmits the result regarding the connection with ECU 30 to display device 60 (S22). In the example of FIG. 4, communicator 51 of gateway SW 50 transmits, to display device 60 of the user of tool 200, information indicating that the provisionally registered information has been registered.

Next, upon receiving the result, display device 60 displays the received result (S23).

FIG. 5 is a diagram illustrating a first example of the determination result displayed by display device 60 according to the present embodiment. FIG. 5 illustrates a display example of the result regarding the connection with ECU 30.

As illustrated in FIG. 5, display device 60 displays that ECU 30 has been registered as the destination for tool 200 (table T has been updated) and that ECU 30 will be automatically recognized and connected thereafter (connection tunneling will be performed). This can notify the user of tool 200 that ECU 30 has been registered in table T as the destination for tool 200.

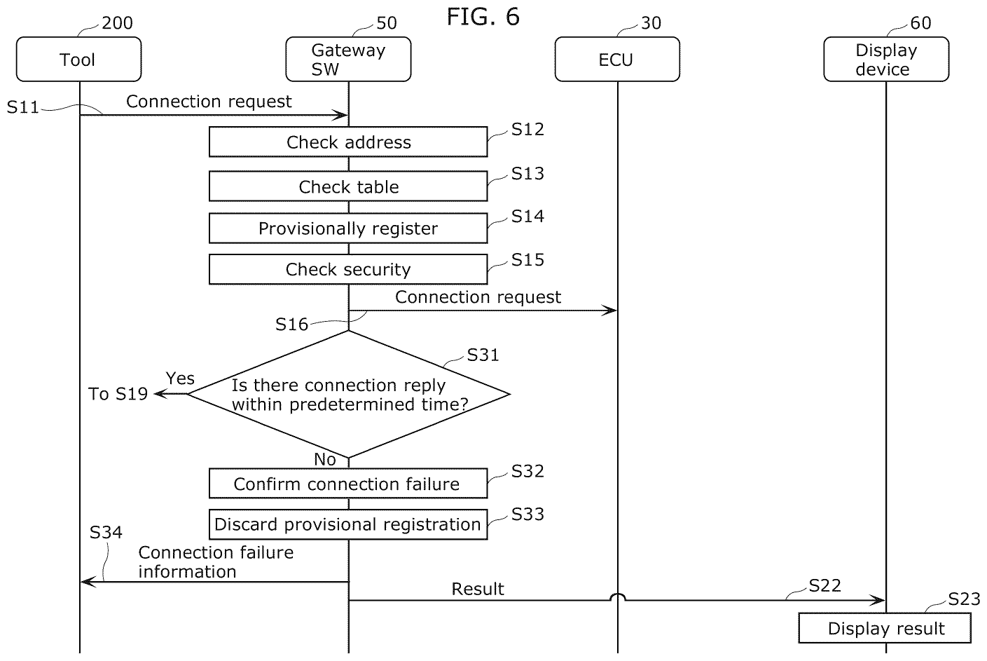

Subsequently, the operations when no connection with ECU 30 is established will be described with reference to FIG. 6. FIG. 6 is a sequence diagram illustrating a second example of the operations (relay method) of communication system 1 according to the present embodiment. Note that operations similar to those in FIG. 4 are denoted by the same step numbers as those in FIG. 4, and the description thereof will be omitted or simplified.

As illustrated in FIG. 6, after transmitting the connection request to ECU 30 (S16), gateway SW 50 determines whether there is a connection reply within a predetermined time (S31). When there is a connection reply within the predetermined time (Yes in S31), the process proceeds to step S19 illustrated in FIG. 4, and when there is no connection reply within the predetermined time (No in S31), the process proceeds to step S32.

In step S31, the determination may be performed based on whether a frame indicating a connection failure has been received from ECU 30. For example, when ECU 30 cannot recognize the connection request, the determination in step S31 is performed as “No”. The establishment of the connection between gateway SW 50 (for example, communicator 51) and the second communication device as the transmission destination (in this case, ECU 30) is an example of the predetermined condition.

Next, when there is no connection reply within the predetermined time, gateway SW 50 confirms a connection failure (S32). For example, controller 52 determines that no connection has been established because the connection failure has been confirmed.

Next, when no connection is established, that is, when the predetermined condition is not satisfied, gateway SW 50 discards the provisional registration (S33). When the predetermined condition is not satisfied, updater 55 deletes the provisionally registered information from table T.

Next, gateway SW 50 transmits connection failure information indicating that the connection with ECU 30 fails to tool 200 (S34). In this case, connection tunneling is not started between tool 200 and ECU 30.

Note that tool 200 may be configured to be able to present the connection failure information to the user. Tool 200 may include, for example, the notifier such as the display, light emitter, or vibration generator, as described above.

Next, gateway SW 50 transmits the result regarding the connection with ECU 30 to display device 60 (S22). In the example of FIG. 6, when the connection has not been established between gateway SW 50 and ECU 30, communicator 51 of gateway SW 50 transmits, to display device 60 of the user of tool 200, information indicating that no connection is established.

Next, upon receiving the result, display device 60 displays the received result (S23).

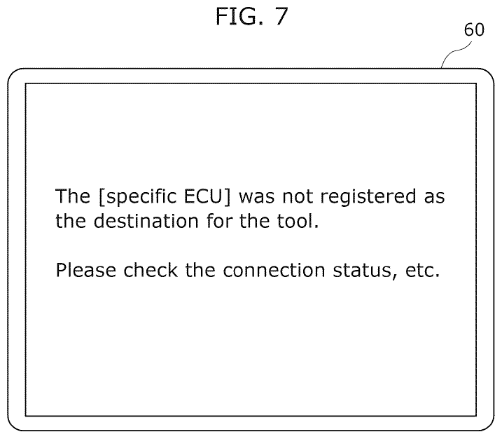

FIG. 7 is a diagram illustrating a second example of the determination result displayed by display device 60 according to the present embodiment. FIG. 7 is a display example of the information indicating that the connection has not been established.

As illustrated in FIG. 7, display device 60 displays that ECU 30 was not registered as the destination for tool 200, along with information indicating a check item, such as “Please check the connection status, etc.”.

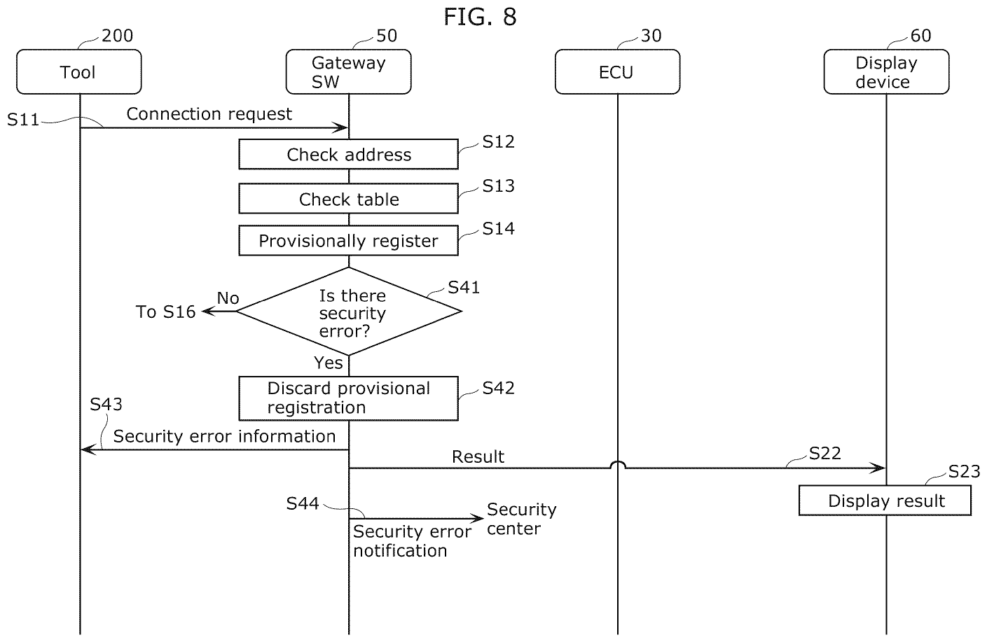

Subsequently, operations when a security error is detected will be described with reference to FIG. 8. FIG. 8 is a sequence diagram illustrating a third example of the operations (relay method) of communication system 1 according to the present embodiment. Note that operations similar to those in FIG. 4 are denoted by the same step numbers as those in FIG. 4, and the description thereof will be omitted or simplified.

As illustrated in FIG. 8, after provisionally registering the address (S14), gateway SW 50 performs a security check to determine whether there is a security error relating to tool 200. When there is a security error (Yes in S41), the process proceeds to step S42, and when there is no security error (No in S41), the process proceeds to step S16 illustrated in FIG. 4. The absence of a security error detected in the security check is an example of the predetermined condition.

Next, when there is a security error, that is, when the predetermined condition is not satisfied, gateway SW 50 discards the provisional registration (S42). Updater 55 deletes the provisionally registered information from table T.

Next, gateway SW 50 transmits security error information indicating that there is a security error to tool 200 (S43). In this case, connection tunneling is not started between tool 200 and ECU 30.

Note that tool 200 may be configured to present the security error information to the user. Tool 200 may include, for example, the notifier such as the display, light emitter, or vibration generator, as described above.

Next, gateway SW 50 transmits the result regarding the presence of a security error to display device 60 (S22). In the example of FIG. 8, when a security error relating to tool 200 is detected in the security check, communicator 51 of gateway SW 50 transmits, to display device 60 of the user of tool 200, information indicating that a security error has been detected.

Next, upon receiving the result, display device 60 displays the received result (S23).

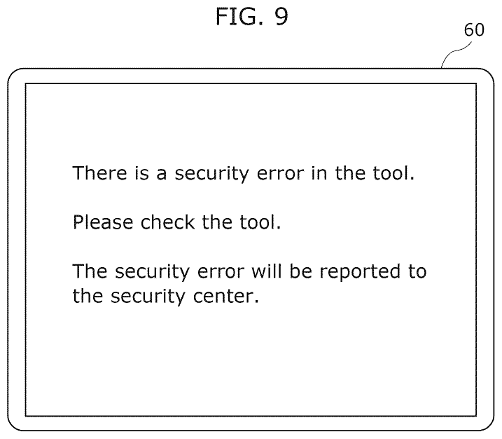

FIG. 9 is a diagram illustrating a third example of the determination result displayed by display device 60 according to the present embodiment. FIG. 9 is a display example of the information indicating that a security error has been detected.

As illustrated in FIG. 9, display device 60 displays information indicating that there is a security error in tool 200, and a check item, such as “Please check tool 200”, along with a message that the security error will be reported to the security center.

Referring again to FIG. 8, gateway SW 50 notifies the security center of a security error (S44). When a security error relating to tool 200 is detected in the security check, communicator 51 of gateway SW 50 transmits, to the security center, information indicating that a security error has been detected.

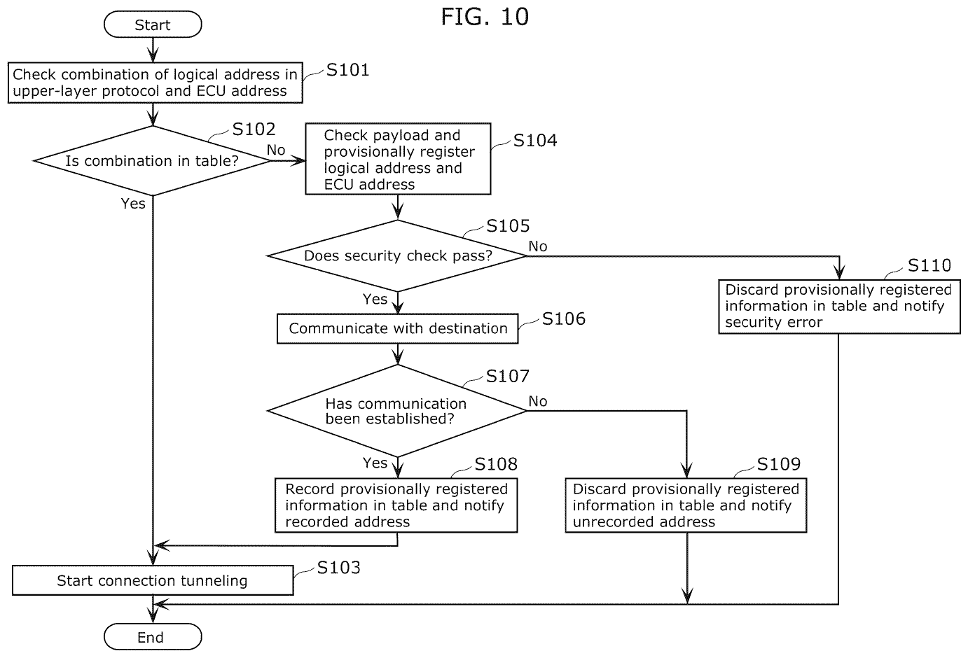

Subsequently, the operations of gateway SW 50 will be described with reference to FIG. 10. FIG. 10 is a flowchart illustrating the operations (relay method) of gateway SW 50 according to the present embodiment.

As illustrated in FIG. 10, upon receiving a frame for a connection request, controller 52 of gateway SW 50 checks a combination of a logical address in an upper-layer protocol, acquired based on the upper header of the frame, and an ECU address (S101). Controller 52 determines whether the combination of the logical address and the ECU address is in table T (S102).

When determining that the combination is in table T (Yes in S102), controller 52 starts connection tunneling (S103).

When controller 52 determines that the combination is not in table T (No in S102), analyzer 53 checks (analyzes) the payload of the frame, and updater 55 provisionally registers the logical address and an ECU address in table T based on the analysis result of analyzer 53 (S104). The ECU address to be provisionally registered is an address identified by the analysis of the payload of the frame by analyzer 53.

Next, security checker 54 determines whether tool 200 passes the security check (S105).

Next, when the security check passes (Yes in S105), controller 52 attempts to communicate with the destination ECU (in the example illustrated in FIG. 4 and the like, ECU 30) (S106), and determines whether communication with the destination ECU has been established (for example, whether there is a connection reply within a predetermined time) (S107).

Next, when communication (connection) has been established (Yes in S107), updater 55 records the provisionally registered information in table T (main registration), and controller 52 notifies the recorded address (S108) and proceeds to step S103. In step S108, controller 52 causes display device 60 to display the content illustrated in FIG. 5 as a notification of the recorded address.

When communication has not been established (No in S107), updater 55 discards the provisionally registered information in table T, and controller 52 notifies the address that was not recorded (S109). In step S109, controller 52 causes display device 60 to display the content illustrated in FIG. 7 as a notification of the address that was not recorded.

When the security check fails, that is, when there is a security error (No in S105), updater 55 discards the provisionally registered information in table T, and controller 52 notifies the security center of the security error (S110). In step S110, controller 52 may cause display device 60 to display the content illustrated in FIG. 9 as a notification that there is a security error.

Note that step S101 corresponds to step S12 illustrated in FIG. 4 and the like, step S102 corresponds to step S13 illustrated in FIG. 4 and the like, step S104 corresponds to step S14 illustrated in FIG. 4 and the like, and step S105 corresponds to step S15 illustrated in FIG. 4 and the like or step S41 illustrated in FIG. 8. Step S106 corresponds to step S16 illustrated in FIG. 4 and the like, step S107 corresponds to step S31 illustrated in FIG. 6, step S108 corresponds to steps S20 and S22 illustrated in FIG. 4, step S109 corresponds to steps S33 and S22 illustrated in FIG. 6, and step S110 corresponds to steps S42 and S44 illustrated in FIG. 8.

### Other Embodiments

Although the relay device and the like according to one or more aspects have been described based on the embodiment, the present disclosure is not limited to the present embodiment. Unless departing from the gist of the present embodiment, various modifications to the present embodiment that a person skilled in the art may conceive, or forms constructed by combining components of different embodiments, may be included in the present disclosure.

For example, in the above embodiment, an example in which updater 55 performs provisional registration and then registers the provisionally registered information when a predetermined condition is satisfied has been described. However, the present invention is not limited thereto, and information may be registered without being provisionally registered. In this case, table T illustrated in FIG. 3 may not include information indicating whether provisional registration has been performed, such as a provisional registration or a registration date and time.

For example, in the above embodiment, an example in which communication system 1 is installed in vehicle 100 has been described, but vehicle 100 is not limited to a passenger car, and may be a bus, a truck, or the like. Communication system 1 may be installed in other mobile bodies such as ships, railways, or flying vehicles (for example, drones), or in stationary devices such as manufacturing equipment.

For example, in the above embodiment, tool 200 has been exemplified as the first communication device and each of ECU 10 and the like has been exemplified as the second communication device, but the present invention is not limited thereto. The first communication device may be each of ECU 10 and the like, and the second communication device may be tool 200. Gateway SW 50 may be capable of reducing the processing load for a frame transmitted from one to the other, where the one is either tool 200 or each of ECU 10 and the like.

In the above embodiment, each component may be configured by dedicated hardware or may be implemented by executing a software program suitable for each component. Each component may be implemented by a program executor, such as a central processing unit (CPU) or a processor, reading and executing a software program recorded on a recording medium, such as a hard disk or a semiconductor memory.

The order in which the steps in the flowchart are executed is illustrated to specifically describe the present disclosure and may be any order other than the one described above. Some of the above steps may be executed simultaneously (in parallel) with other steps, or some of the above steps may not be executed.

The division of the functional blocks in the block diagram is an example. A plurality of functional blocks may be implemented as one functional block, one functional block may be divided into a plurality of functional blocks, or some functions may be transferred to other functional blocks. The functions of a plurality of functional blocks having similar functions may be processed in parallel or in a time-division manner by a single piece of hardware or software.

The relay device according to the above embodiment may be implemented as a single device or by a plurality of devices. When the relay device is implemented by a plurality of devices, the components of the relay device may be allocated to the plurality of devices in any manner. When the relay device is implemented by a plurality of devices, the communication method between the plurality of devices is not particularly limited, and may be wireless or wired communication. Wireless and wired communications may be combined between the devices.

Each of the components described in the above embodiments may be implemented as software or typically as a large-scale integrated circuit (LSI) that is an integrated circuit. These may be formed into separate chips, or one chip may be formed to include some or all of them. Although LSI has been mentioned here, the circuit is sometimes referred to as an integrated circuit (IC), system LSI, super LSI, or ultra LSI, depending on the degree of integration. The integrated circuit method is not limited to LSI and may be implemented using a dedicated circuit (a general-purpose circuit that executes a dedicated program) or a general-purpose processor. A field programmable gate array (FPGA), which can be programmed after LSI manufacturing, or a reconfigurable processor, which can reconfigure the connections and settings of circuit cells inside the LSI, may be used. Furthermore, if an integrated circuit technology that replaces LSI emerges due to advancements in semiconductor technology or other related technologies, the components may naturally be integrated using that technology.

The system LSI is a super multifunctional LSI manufactured by integrating a plurality of processing units on a single chip. More specifically, the system LSI is a computer system including a microprocessor, read-only memory (ROM), random-access memory (RAM), and the like. The ROM stores a computer program. When the microprocessor operates according to the computer program, the system LSI achieves the function.

One aspect of the present disclosure may be a computer program for causing a computer to execute each characteristic step included in the relay method illustrated in one of FIGS. 4, 6, 8, and 10.

For example, the program may be a program for causing the computer to perform execution. Another aspect of the present disclosure may be a non-transitory computer-readable recording medium having recorded such a program thereon. For example, such a program may be recorded on a recording medium and distributed or circulated. For example, by installing the distributed program on a device equipped with another processor and causing the processor to execute the program, it is possible to cause the device to perform each of the above processes.

### (Supplementary Note)

### (Technique 1)

A relay device that relays a frame transmitted and received through connection-oriented communication between a first communication device and each of one or more second communication devices, the frame including in a header portion: a destination address that designates the relay device in a connection protocol for performing the connection-oriented communication; and an upper-layer address that designates a second communication device as a transmission destination in an upper-layer protocol higher than the connection protocol, the relay device including: a communicator that receives the frame from the first communication device; a controller that determines whether a first address is included in a table associating the destination address with the upper-layer address, the first address being acquired based on the header portion of the frame received by the communicator, and being the upper-layer address of the second communication device as the transmission destination for the frame among the one or more second communication devices; an analyzer that analyzes a payload of the frame to identify a second address that is the destination address of the second communication device as the transmission destination for the frame, when the first address is not included in the table; and an updater that updates the table based on additional information associating the first address with the second address.

Thus, when the first address is not included in table T, updater 55 updates table T. That is, when a frame including the first address is received again, the frame can be transferred to the second communication device as the transmission destination without analysis of the payload by analyzer 53. Therefore, it is possible to implement a relay device capable of reducing the processing load more than before when a frame including the first address that is not included in table T is received.

### (Technique 2)

The relay device according to technique 1, wherein the updater provisionally registers the additional information in the table, and when a predetermined condition is satisfied, the updater registers the additional information in the table.

This enables the additional information to be registered in the table only when a predetermined condition is satisfied, thereby suppressing the increase in the processing amount of the relay device caused by the registration of unnecessary additional information.

### (Technique 3)

The relay device according to technique 2, further including: a checker that executes a security check for the first communication device, wherein the predetermined condition includes that no error is detected in the security check.

Thus, the address of the first communication device included in a frame in which a security error has been detected can be prevented from being registered in table T. This leads to an improvement in the security performance of communication system 1.

### (Technique 4)

The relay device according to technique 2 or 3, wherein the communicator transmits the frame, in which the destination address has been converted to the second address, to a second communication device as a transmission destination, and the predetermined condition includes that a connection is established between the relay device and the second communication device as the transmission destination.

Thus, it is possible to prevent the registration of the address of the second communication device that cannot communicate, or is not permitted to communicate, with the first communication device.

### (Technique 5)

The relay device according to any one of techniques 2 to 4, wherein when the predetermined condition is not satisfied, the updater discards the additional information provisionally registered in the table.

Thus, it is possible to prevent additional information that will not be used from remaining in the table. It is possible to suppress the increase in the amount of information in table T.

### (Technique 6)

The relay device according to any one of techniques 2 to 5, wherein the table associates the destination address, the upper-layer address, and information indicating whether the destination address and the upper-layer address have been provisionally registered.

Thus, it is possible to easily identify, based on the information, whether the combination of the destination address and the upper-layer address registered in the table has been provisionally registered.

### (Technique 7)

The relay device according to any one of techniques 2 to 6, wherein the table associates the destination address, the upper-layer address, and information indicating a date and time of registration.

Thus, it is possible to easily identify, based on the date and time, whether the combination of the destination address and the upper-layer address registered in the table has been provisionally registered.

### (Technique 8)

The relay device according to any one of techniques 2 to 7, wherein when the additional information is registered, the communicator transmits, to a terminal device of a user of the first communication device, information indicating that the additional information has been registered.

Thus, it is possible to notify the user that the additional information has been registered in the table, that is, the processing load on the relay device can be reduced.

### (Technique 9)

The relay device according to technique 3, wherein when an error relating to the first communication device is detected in the security check, the communicator transmits, to a terminal device of a user of the first communication device, information indicating that an error has been detected.

Thus, it is possible to notify the user that a security error has been detected.

### (Technique 10)

The relay device according to technique 3, wherein when an error relating to the first communication device is detected in the security check, the communicator transmits, to a security center, information indicating that an error has been detected.

Thus, it is possible to notify the security center that a security error has been detected. The security error is utilized for analysis in the security center.

### (Technique 11)

The relay device according to technique 4, wherein when no connection is established with the second communication device as the transmission destination, the communicator transmits, to a terminal device of a user of the first communication device, information indicating that no connection is established.

Thus, it is possible to notify the user that no connection is established.

### (Technique 12)

The relay device is the relay devices according to any one of techniques 1 to 11, provided in a vehicle.

Thus, the processing load on the relay device can be reduced in resource-limited environments such as vehicle 100.

### (Technique 13)

The relay device according to technique 12, wherein one of the first communication device and the second communication device is a device for diagnosing the vehicle, and an other of the first communication device and the second communication device is an ECU provided in the vehicle.

Thus, the processing load in the communication between the device for diagnosing vehicle 100 and the ECU can be reduced.

### (Technique 14)

A relay method executed by a relay device that relays a frame transmitted and received through connection-oriented communication between a first communication device and each of one or more second communication devices, the frame including in a header portion: a destination address that designates the relay device in a connection protocol for performing the connection-oriented communication; and an upper-layer address that designates a second communication device as a transmission destination in an upper-layer protocol higher than the connection protocol, the relay method including: receiving the frame from the first communication device; determining whether a first address is included in a table associating the destination address with the upper-layer address, the first address being acquired based on the header portion of the frame received, and being the upper-layer address of the second communication device as the transmission destination for the frame among the one or more second communication devices; analyzing a payload of the frame to identify a second address that is the destination address of the second communication device as the transmission destination for the frame, when the first address is not included in the table; and updating the table based on additional information associating the first address with the second address.

Thus, the same effect as that of the relay device is achieved.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2023-217288 filed on Dec. 22, 2023.

### INDUSTRIAL APPLICABILITY

The present disclosure is useful for communication devices and the like that perform connection-oriented communication.

The invention claimed is:

1. A relay device that relays a frame transmitted and received through connection-oriented communication between a first communication device and each of one or more second communication devices, the frame including in a header portion:
a destination address that designates the relay device in a connection protocol for performing the connection-oriented communication; and
an upper-layer address that designates a second communication device as a transmission destination in an upper-layer protocol higher than the connection protocol,
the relay device comprising:
a communicator that receives the frame from the first communication device;
a controller that determines whether a first address is included in a table associating the destination address with the upper-layer address, the first address being acquired based on the header portion of the frame received by the communicator, and being the upper-layer address of the second communication device as the transmission destination for the frame among the one or more second communication devices;
an analyzer that analyzes a payload of the frame to identify a second address that is the destination address of the second communication device as the transmission destination for the frame, when the first address is not included in the table; and
an updater that updates the table based on additional information associating the first address with the second address.

2. The relay device according to claim 1,
wherein the updater provisionally registers the additional information in the table, and when a predetermined condition is satisfied, the updater registers the additional information in the table.

3. The relay device according to claim 2, further comprising:
a checker that executes a security check for the first communication device,
wherein the predetermined condition includes that no error is detected in the security check.

4. The relay device according to claim 2,
wherein the communicator transmits the frame, in which the destination address has been converted to the second address, to a second communication device as a transmission destination, and
the predetermined condition includes that a connection is established between the relay device and the second communication device as the transmission destination.

5. The relay device according to claim 2,
wherein when the predetermined condition is not satisfied, the updater discards the additional information provisionally registered in the table.

6. The relay device according to claim 2,
wherein the table associates the destination address, the upper-layer address, and information indicating whether the destination address and the upper-layer address have been provisionally registered.

7. The relay device according to claim 2,
wherein the table associates the destination address, the upper-layer address, and information indicating a date and time of registration.

8. The relay device according to claim 2,
wherein when the additional information is registered, the communicator transmits, to a terminal device of a user of the first communication device, information indicating that the additional information has been registered.

9. The relay device according to claim 3,
wherein when an error relating to the first communication device is detected in the security check, the communicator transmits, to a terminal device of a user of the first communication device, information indicating that an error has been detected.

10. The relay device according to claim 3,
wherein when an error relating to the first communication device is detected in the security check, the communicator transmits, to a security center, information indicating that an error has been detected.

11. The relay device according to claim 4,
wherein when no connection is established with the second communication device as the transmission destination, the communicator transmits, to a terminal device of a user of the first communication device, information indicating that no connection is established.

12. The relay device according to claim 1
wherein the relay device is provided in a vehicle.

13. The relay device according to claim 12,
wherein one of the first communication device and the second communication device is a device for diagnosing the vehicle, and
an other of the first communication device and the second communication device is an electronic control unit (ECU) provided in the vehicle.

14. The relay device according to claim 1,
wherein the updater registers the additional information in the table regardless of whether a predetermined condition is satisfied.

15. The relay device according to claim 3,
wherein when an error is detected in the security check, a result including that the error has been detected is displayed on a display device.

16. The relay device according to claim 4,
wherein a result indicating whether a connection has been established between the relay device and the second communication device as the transmission destination is displayed on a display device.

17. The relay device according to claim 7,
wherein the additional information provisionally registered in the table is not accompanied by the information indicating the date and time of registration.

18. The relay device according to claim 12,
wherein a device for diagnosing the vehicle is configured to be detachable from the relay device.

19. A relay method executed by a relay device that relays a frame transmitted and received through connection-oriented communication between a first communication device and each of one or more second communication devices, the frame including in a header portion:
a destination address that designates the relay device in a connection protocol for performing the connection-oriented communication; and
an upper-layer address that designates a second communication device as a transmission destination in an upper-layer protocol higher than the connection protocol,
the relay method comprising:
receiving the frame from the first communication device;
determining whether a first address is included in a table associating the destination address with the upper-layer address, the first address being acquired based on the header portion of the frame received, and being the upper-layer address of the second communication device as the transmission destination for the frame among the one or more second communication devices;
analyzing a payload of the frame to identify a second address that is the destination address of the second communication device as the transmission destination for the frame, when the first address is not included in the table; and
updating the table based on additional information associating the first address with the second address.

20. A non-transitory computer-readable recording medium having recorded thereon a program for causing a computer to execute the relay method according to claim 19.
